(19) United States
(12) Patent Application Publication
(10) Pub. No.: US 2017/0258675 A1
(43) Pub. Date: Sep. 14, 2017

(54) LOWER LIMB MASSAGER

(71) Applicant: Jianhan Zou, Xiamen (CN)

(72) Inventors: Jianhan Zou, Xiamen (CN); Guoyun Tang, Xiamen (CN); Yongjin Wang, Xiamen (CN); Jinyao Li, Xiamen (CN)

(21) Appl. No.: 15/604,771

(22) Filed: May 25, 2017

Related U.S. Application Data
(63) Continuation of application No. PCT/CN2015/075821, filed on Apr. 3, 2015.

(30) Foreign Application Priority Data
Nov. 26, 2014 (CN) 201410686317.5

(51) Int. Cl. A61H 23/00; A61H 15/00; A61H 7/00

(52) U.S. Cl. CPC A61H 23/00; A61H 7/004; A61H 7/007; A61H 15/00; A61H 2205/12

(57) ABSTRACT

The present invention relates to a lower limb massager comprising a cover body, a base and a massager core. The massager core comprises a heel massaging mechanism comprising a drive device and a vibration device. The drive device comprises a motor, a drive shaft and an eccentric rotor. The vibration device comprises a support member and a guide member. The support member comprises a supporting plate for heels and a deflection sleeve configured to drive the supporting plate to vibrate. The deflection sleeve is mounted on the eccentric rotor and has a deflection axis coinciding with a rotation axis of the eccentric rotor. The guide member is hinged with the base at one end and hinged with the support member at the other end so as to define a deflection angle of the deflection sleeve. The massager can massage the heels and calves simultaneously.

### CROSS-REFERENCE TO RELATED APPLICATION

This application is a continuation application of International Patent Application No. PCT/CN2015/075821, filed on Apr. 3, 2015, which itself claims priority to Chinese Patent Application No. 201410686317.5, filed on Nov. 26, 2014 in the State Intellectual Property Office of P.R. China, which are hereby incorporated herein in their entireties by reference.

### FIELD OF THE INVENTION

The present invention relates to the field of massage appliances, in particular to a lower limb massager with vibration massage functions.

### BACKGROUND OF THE INVENTION

A lower limb massager is a healthcare massage equipment for massaging acupoints on feet of a human body, which massaging can reduce fatigue, relieve tension and improve sleep so as to improve the health of the human body. A traditional lower limb massager can only perform local massage of the feet and has the disadvantages of undesirable massage effect, relatively complex structure and high cost. In a foot-sole massaging machine disclosed in Patent Application No. CN102106780A, an eccentric wheel mechanism driven by a motor to oscillate back and forth is adopted to simultaneously massage multiple parts such as tiptoes, foot arches of foot soles. However, this foot massaging machine is provided with a bearing surface for heels and thus is unable to massage the heels, so that fewer parts can be massaged. As an improvement to the above foot-sole massaging machine, a foot massaging machine disclosed in patent No. CN202844098U is additionally provided with a heel massaging mechanism which allows the whole foot sole to be massaged. However, since no bearing surface for heels is provided, a massage plate oscillates back and forth during the massage such that the foot cannot have good contact with the massage plate, leading to a weakened massage effect. In addition, the massages performed by existing lower limb massagers to the heels are rubbing and kneading which are unsatisfactory due to the low sensitivity of the heels.

### SUMMARY OF THE INVENTION

The technical problem to be solved by the present invention is to provide a lower limb massager which has better massage effect and is simple in structure, so as to overcome the above deficiencies existing in the prior art.

In order to solve the above technical problem, the present invention adopts the following technical solution:

A lower limb massager comprising a cover body, a base and a massager core. The massager core comprises a heel massaging mechanism comprising a drive device and a vibration device. The drive device comprises a motor, a drive shaft and an eccentric rotor. The vibration device comprises a support member and a guide member. The support member comprises a supporting plate for heels and a deflection sleeve configured to drive the supporting plate to vibrate for massaging the lower limbs in a vibrating way. The deflection sleeve is mounted on the eccentric rotor and has a deflection axis coinciding with a rotation axis of the latter. The guide member is hinged with the base at one end and hinged with the support member at the other end so as to define a deflection angle of the deflection sleeve.

The present invention may be further improved by the following technical measures.

A rolling bearing is mounted between the deflection sleeve and the eccentric rotor. The massager core further comprises a tiptoe massage member and a foot-arch massage member. The foot-arch massage member is a roller wheel, and the tiptoe massage member is a rubbing and kneading plate which is connected with a crank shaft arranged on a roller by a connecting rod. Alternatively, both the foot-arch massage member and the tiptoe massage member are roller wheels between which the transmission is carried out by means of a gear mechanism. The base is provided thereon with a metal liner to which the vibration device is fixedly connected. A hinge seat, which is movably hinged with the guide member and is fixedly connected with the metal liner, is fixedly mounted on the base. A heel seat for placing the heel is mounted on the base and is provided at the bottom with an opening for allowing the support member to move up and down. The heel seat is provided at its side edge with a protection plate for surrounding the rear side of the foot. Both the support member and the base are provided with a fork-shaped hinge seat in which a hinged end of the guide member is located. A rolling bearing is embedded in the hinged end of the guide member with its inner ring fixedly connected with a hinge pin shaft.

Due to the adoption of the above technical measures, the present invention has following advantageous effects.

The heel massaging mechanism of the present invention is a massaging mechanism capable of vibration, by which the heels and legs are driven to vibrate simultaneously, thus producing a vibration massaging effect. The simultaneous massaging of the feet and legs enables a leg shaping function and thus overcomes the drawback of singleness in massaging effect of a conventional lower limb massager which can only perform rubbing and kneading to the feet.

Besides, the heel massaging mechanism of the present invention has the advantageous effects of stability and security. In order to prevent the heels from being hurt due to dropping from the support member during vibration, the heel seat and protection plate are provided at the heel part of the present invention. In order to allow the support member to oscillate within a certain range so as to produce the vibration effect, the guide member is provided which is hinged at two ends with the support member and the base, respectively, thus not only is the left and right deflection of the support member prevented, but also a range of oscillation angles of the support member is limited.

### BRIEF DESCRIPTION OF THE DRAWINGS

FIG. 1 is a schematic view illustrating an overall structure of an embodiment of the present invention;

FIG. 2 is a schematic view illustrating an internal assembly structure of an embodiment of the present invention;

FIG. 3 is a schematic view of assembled components of the heel massaging mechanism of the embodiment;

FIG. 4 is a structural view of an eccentric rotor of the embodiment; and

FIG. 5 is a structural view of a deflection sleeve of the embodiment.

### DETAILED DESCRIPTION OF THE INVENTION

A detailed description of specific embodiments of the invention will be made below in connection with the drawings.

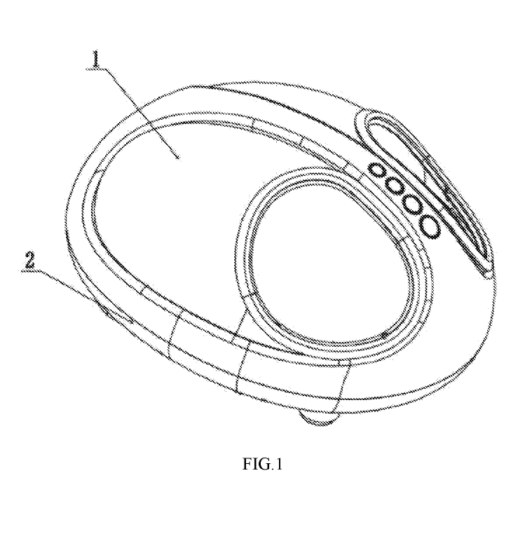

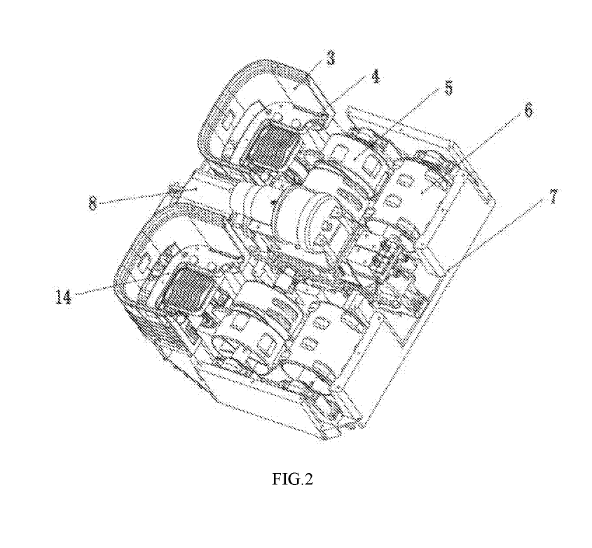

As shown in FIGS. 1-3, a lower limb massager comprises a cover body 1, a base 2 comprising a base plate 7 and a lower cover, and a massager core fixedly mounted on the base plate 7. The cover body 1 is provided with two foot holes each having a cloth foot covering mounted therein for preventing a user's foot from inserting into the machine body. The massager core comprises a heel massaging mechanism, a foot-arch massage member 5 and a tiptoe massage member 6. The heel massaging mechanism comprises a vibration device and a drive device comprising a motor 8, a drive shaft and an eccentric rotor 9. The motor 8 brings the drive shaft 11 into rotation by means of a belt wheel transmission mechanism. Both ends of the drive shaft 11 are mounted on the base plate 7 through a bearing seat. The eccentric rotor 9, which has a circular outer contour, is fixedly mounted on the drive shaft 11 with its rotation axis deviating from its center of a circle. When the drive shaft 11 rotates, the eccentric rotor 9 rotates with the drive shaft 11 like a cam mechanism.

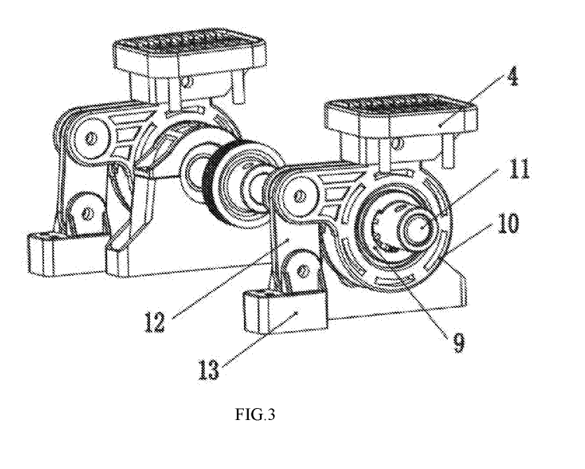

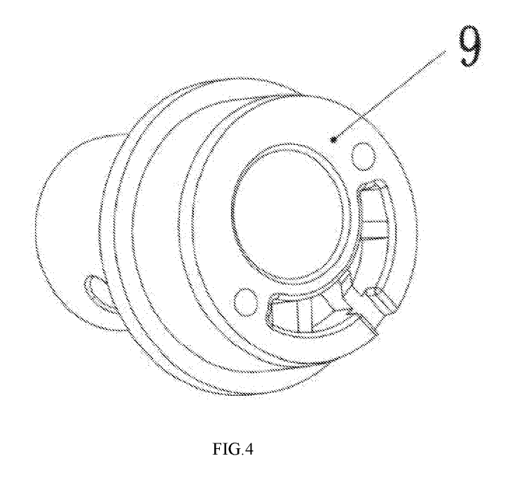

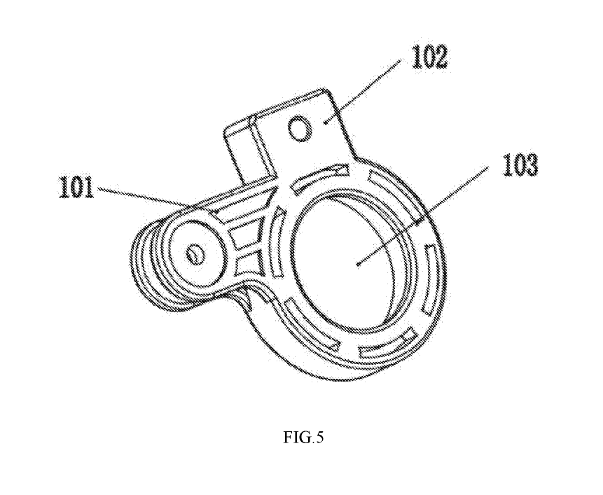

As shown in FIGS. 3-5, a vibration device comprises a support member and a guide member 12. The support member comprises a supporting plate 4 for heels and a deflection sleeve 10 configured to drive the supporting plate to vibrate for massaging the lower limbs in a vibrating way. The deflection sleeve 10 is mounted on the eccentric rotor 9 with a rolling bearing mounted therebetween. An outer ring of the rolling bearing is secured within a bearing mounting hole 103 of the deflection sleeve 10, and an inner ring of the rolling bearing is secured on the outer contour of the eccentric rotor 9. The deflection sleeve 10 has a deflection axis coinciding with the rotation axis of the eccentric rotor 9. The guide member 12 is a connecting rod which is movably hinged at one end on the base 2 and hinged at the other end with the support member so as to limit a deflection angle of the deflection sleeve 10.

The guide member 12 is mounted on the base plate 7 by means of a hinge seat 13 secured on the base plate 7 and is movably hinged with the hinge seat 13. The hinge seat 13 comprises two ears forming a fork shape and having the lower end of the guide member 12 located therebetween. The guide member 12 is hinged with the hinge seat 13 by means of a pin shaft.

The deflection sleeve 10 comprises a hinge portion 101 and a connection portion 102 to which the supporting plate 4 is fixedly connected by means of the pin shaft. A rubber pad is mounted on the supporting plate 4 on which the heel is supported when the present invention is in use. The guide member 12 is movably hinged, by means of the pin shaft, with the hinge portion 101 having two ears, and has its upper end located between the two ears. In order to reduce wear and noise and prolong the service lift of the hinged end, a rolling bearing is embedded in each end of the guide member 12 with its inner ring secured with the hinge pin shaft.

When the eccentric rotor 9 drives the deflection sleeve 10 to oscillate, the guide member 12 is configured to restrain the movement of the deflection sleeve 10 in an axis direction of the drive shaft 11 and to define the deflection angle of the deflection sleeve 10 on the eccentric rotor 9.

The base 2 is provided thereon with a metal liner to which foot seats of the vibration device are both fixedly connected, especially the hinge seat 13. A rubber pad is arranged between the metal liner and the base 2, which may provide a cushioning and noise-reducing effect. The metal liner may strengthen the base 2 so as to prevent fatigue failure of the latter resulting from long-term vibration.

The massager core further comprises a tiptoe massage member 6 and a foot-arch massage member 5. Both the foot-arch massage member 5 and the tiptoe massage member 6 are roller wheels between which the transmission is carried out by means of a gear mechanism. Transmission between the motor 8 and the drive shaft 11 is realized through a belt mechanism which has the advantages of smooth transmission and low noise.

A heel seat 14 for placing the heel is mounted on the base 2 and is provided at the bottom with an opening for allowing up and down movement of the support member which, during vibration massage, moves up and down within the opening. The heel seat 14 is provided at its side edge with a protection plate 3 which surrounds the rear side of the foot to limit the heel so as to prevent the heel from coming into collision with other components.

In the above embodiment, the foot-arch massage member 5 or the tiptoe massage member 6 can also be a rubbing and kneading plate which is connected with a crank arranged on the roller by the connecting rod, while the massaging mechanism can be a roller wheel. Upon rotation, the crank drives the rubbing and kneading plate to slide forward or backward on the base 2, thus forming a crank-slider mechanism.

In actual operation of the present invention, the motor 8 brings the drive shaft 11 into rotation by means of the transmission mechanism. As the eccentric rotor 9 is fixedly mounted on the drive shaft 11, the former performs eccentric movement under the driving of the drive shaft 11, which movement drives the deflection sleeve 10 to deflect. The deflection angle is limited by the deflection sleeve 10. The deflection sleeve 10 oscillates to drive the supporting plate 4 to move up and down, so as to realize the vibration massage of the heel.

The above embodiments are merely preferred technical solutions, and any insubstantial difference made based on the above embodiments constitutes patent infringement to the present invention.

What is claimed is:

1. A lower limb massager, comprising a cover body, a base and a massager core comprising a heel massaging mechanism, and characterized in that the heel massaging mechanism comprises a drive device and a vibration device, wherein the drive device comprises a motor, a drive shaft and an eccentric rotor; the vibration device comprises a support member and a guide member; the support member comprises a supporting plate for heels and a deflection sleeve configured to drive the supporting plate to vibrate for massaging the lower limbs in a vibrating way; the deflection sleeve is mounted on the eccentric rotor and has a deflection axis coinciding with a rotation axis of the eccentric rotor; the eccentric motion of the eccentric rotor results in the deflection of the deflection sleeve; and the guide member is hinged with the base at one end and hinged with the support member at the other end so as to define a deflection angle of the deflection sleeve.

2. The lower limb massager according to claim 1, characterized in that a rolling bearing is mounted between the deflection sleeve and the eccentric rotor.

3. The lower limb massager according to claim 1, characterized in that the massager core further comprises a tiptoe massage member and a foot-arch massage member.

4. The lower limb massager according to claim 3, characterized in that the foot-arch massage member is a roller wheel, and the tiptoe massage member is a rubbing and kneading plate which is connected with a crank shaft arranged on a roller by means of a connecting rod.

5. The lower limb massager according to claim 3, characterized in that both the foot-arch massage member and the tiptoe massage member are roller wheels between which the transmission is carried out by means of a gear mechanism.

6. The lower limb massager according to claim 1, characterized in that the base is provided thereon with a metal liner to which the vibration device is fixedly connected.

7. The lower limb massager according to claim 6, characterized in that a hinge seat, which is movably hinged with the guide member and is fixedly connected with the metal liner, is fixedly mounted on the base.

8. The lower limb massager according to claim 1, characterized in that a heel seat for placing the heel is mounted on the base and is provided at the bottom with an opening for allowing the support member to move up and down.

9. The lower limb massager according to claim 1, characterized in that the heel seat is provided at its side edge with a protection plate for surrounding the rear side of the foot.

10. The lower limb massager according to claim 1, characterized in that both the support member and the base is provided with a fork-shaped hinge seat in which a hinged end of the guide member is located, and a rolling bearing is embedded in the hinged end of the guide member with its inner ring fixedly connected with a hinge pin shaft.
